(19) United States
(12) Patent Application Publication
(10) Pub. No.: US 2025/0225038 A1
(43) Pub. Date: Jul. 10, 2025

(54) OPERATION MANAGEMENT SYSTEM AND OPERATION MANAGEMENT METHOD

(71) Applicant: Hitachi Vantara, Ltd., Yokohama-shi (JP)

(72) Inventors: Masahiro ARAI, Tokyo (JP); Akira DEGUCHI, Tokyo (JP)

(21) Appl. No.: 18/829,467

(22) Filed: Sep. 10, 2024

(30) Foreign Application Priority Data
Jan. 9, 2024 (JP) 2024-001239

(51) Int. Cl. G06F 11/14

(52) U.S. Cl. CPC G06F 11/1469; G06F 2201/815

(57) ABSTRACT

An operation management system, when restoring backup data to a logical volume in a virtual drive, stores the restored backup data in an external volume of a high-speed virtual drive that is able to be accessed at higher speed than the virtual drive to control a restore computer resource so that the restored data is able to be accessed, and migrates the restored data from the external volume of the high-speed virtual drive to the logical volume of the virtual drive while maintaining a state where the data restored in the external volume of the high-speed virtual drive is accessible.

### CROSS-REFERENCE TO RELATED APPLICATION

The present application claims priority from Japanese application JP2024-001239, filed on Jan. 9, 2024, the content of which is hereby incorporated by reference into this application.

### BACKGROUND OF THE INVENTION

### 1. Field of the Invention

The present invention relates to an operation management system and an operation management method, and is suitably applied to, for example, an operation management system related to technology for executing input/output processing of data with respect to a host.

### 2. Description of Related Art

In recent years, an operation form referred to as a hybrid cloud has emerged in which on-premise information technology (IT) assets and public clouds are used in combination in accordance with costs and purposes. Compared to the on-premise IT assets, the public clouds are characterized by the flexibility of using necessary computer resources on a pay-per-use basis. For example, a virtual machine, which is one of computer resources provided by public clouds (hereafter simply referred to as “clouds”), is charged only when it is operating, and is not charged when it is stopped.

Under such a charge system, a system referred to as an Active/Passive disaster recovery (hereinafter simply referred to as “DR”) has emerged. The Active/Passive DR creates only a backup of data, allocates necessary computer resources to restore the data when a disaster occurs, and operates recovery site (hereinafter referred to as a “secondary site”).

In Amazon Web Services, Inc: Disaster Recovery (DR) Architecture on AWS, Part I: Strategies for Recovery in the Cloud. 2021 Apr. 5. https://aws.amazon.com/jp/blogs/architecture/disaster-recovery-dr-architecture-on-aws-part-i-strategies-for-recovery-in-the-cloud/, technology related to the above-described Active/Passive DR is disclosed. The technology disclosed here can also be applied to a storage system. Data to be protected is stored in the storage system. The data is backed up to a cloud in advance. In the event of a disaster, a storage system is constructed using computer resources of the cloud, and the data backed up as described above is restored. In this manner, it is possible to reduce the costs of a secondary site at normal times, while recovering the storage system in the event of a disaster.

### SUMMARY OF THE INVENTION

As described above, in an Active/Passive DR, it is common for computer resources not to be operated until the start of use in order to reduce operating costs. For this reason, in order to make a storage system on a cloud (hereafter referred to as a cloud storage system) available to a host, it is necessary to start up computer resources, which takes a certain period of recovery time.

The invention has been made in view of the above circumstances, and an object thereof is to propose an operation management system and an operation management method which are capable of shortening a recovery time until the system is available to a host.

In order to solve the above problems, the invention provides an operation management system for a computer, the computer including a backup data store that stores backup data, and a restore computer resource that analyzes the backup data and restores the data, in which the operation management system, when restoring the backup data to a logical volume in a virtual drive, stores the restored backup data in an external volume of a high-speed virtual drive that is able to be accessed at higher speed than the virtual drive to control the restore computer resource so that the restored data is able to be accessed, and migrates the restored data from the external volume of the high-speed virtual drive to the logical volume of the virtual drive while maintaining a state where the restored data in the external volume of the high-speed virtual drive is accessible.

Further, in the invention, there is provided an operation management method for a computer, the computer including a backup data store that stores backup data, and a restore computer resource that analyzes the backup data and restores the data, in which the operation management method includes, when an operation management system restores the backup data to a logical volume in a virtual drive, an access control step of storing the restored backup data in an external volume of a high-speed virtual drive that is able to be accessed at higher speed than the virtual drive to control the restore computer resource so that the restored data is able to be accessed, and a migration processing step of migrating the restored data from the external volume of the high-speed virtual drive to the logical volume of the virtual drive while maintaining a state where the restored data in the external volume of the high-speed virtual drive is accessible.

According to the invention, it is possible to shorten a recovery time until a system is available to a host.

### BRIEF DESCRIPTION OF THE DRAWINGS

FIG. 1 is a block diagram showing a configuration example of an overall system according to a first embodiment;

FIG. 2 is a block diagram showing a configuration example of a cloud storage system shown in FIG. 1;

FIG. 3 is a block diagram showing a configuration example of storage control software of the cloud storage system shown in FIG. 1;

FIG. 4 is a block diagram showing a configuration example of a backup data store shown in FIG. 1;

FIG. 5A is a diagram schematically showing an example of a state where backup data of a volume is created;

FIG. 5B is a diagram schematically showing an example of a state where backup data of a volume is created;

FIG. 5C is a diagram schematically showing an example of a state where backup data of a volume is created;

FIG. 6A is a diagram showing an example of a backup catalog stored in the backup data store;

FIG. 6B is a diagram showing an example of the backup catalog stored in the backup data store;

FIG. 7 is a block diagram showing a configuration example of a restore processing program;

FIG. 8 is a block diagram showing a configuration example of an operation management system shown in FIG. 1;

FIG. 9 is a diagram showing a configuration example of a performance management table included in an information management DB group shown in FIG. 8;

FIG. 10 is a flowchart showing an example of procedures of storage recovery control processing;

FIG. 11 is a flowchart showing an example of procedures of high-speed recovery processing using a virtual drive;

FIG. 12 is a flowchart showing an example of procedures of restore processing for the virtual drive;

FIG. 13 is a flowchart showing an example of procedures of migration processing;

FIG. 14A is a diagram showing an example of a state where migration processing is performed in a background;

FIG. 14B is a diagram showing an example of a state where the migration processing is performed in the background;

FIG. 14C is a diagram showing an example of a state where the migration processing is performed in the background;

FIG. 15 is a flowchart showing an example of post-processing performed by the operation management system when the migration processing performed in the background is completed;

FIG. 16A is a flowchart showing an example of normal recovery processing;

FIG. 16B is a flowchart showing an example of a continuation of the normal recovery processing shown in FIG. 16A;

FIG. 17A is a diagram showing an example of a relationship between required times of processing in the high-speed recovery processing using the virtual drive;

FIG. 17B is a diagram showing an example of a relationship between required times of processing in the normal recovery processing shown in FIG. 14; and

FIG. 18 is a flowchart showing an example of an overall image of storage recovery control processing in a second embodiment.

### DESCRIPTION OF EMBODIMENTS

An embodiment of the invention will be described in detail below with reference to the drawings.

### (1) First Embodiment

In a first embodiment, description will be given of a configuration in which backed up data (hereinafter referred to as “backup data”) is restored to a logical volume on a cloud storage system in a short period of time to thereby shorten a recovery time until the data is accessible to a host. In the following embodiment, regarding such a recovery time, a recovery time to be a target is also referred to as a “target recovery time”.

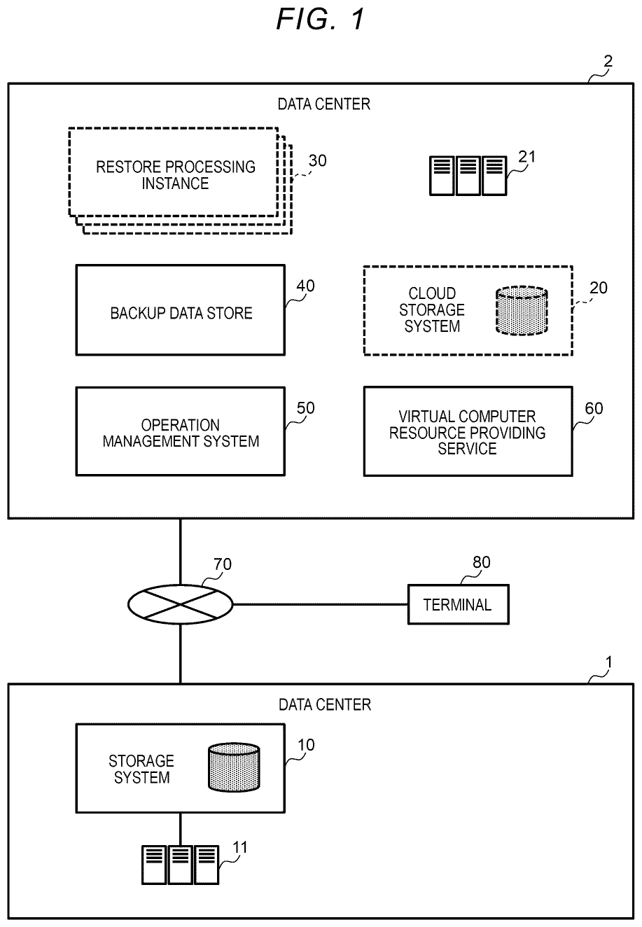

FIG. 1 is a block diagram showing a configuration example of an overall system according to the first embodiment. In the example shown in the drawing, a data center 1 that performs main operations at normal times, a data center 2 that is a backup destination and a recovery destination in the event of a disaster, a terminal 80, and a network 70 are provided.

The data center 1 is, for example, an on-premise system owned by a user as an information technology (IT) asset, and includes a storage system 10 and at least one host. In the data center 1, the storage system 10 performs input/output processing of data with respect to a host 11.

The data center 2 is, for example, a virtual data center provided by a public cloud service provider.

The data center 2 is an example of a computer. In this embodiment, the data center 2 includes at least a restore processing instance 30, a backup data store 40, and an operation management system 50, and preferably includes a cloud storage system 20, a virtual computer resource providing service 60, and a host 21. Among these, the cloud storage system 20 and the restore processing instance 30 shown by dashed lines in FIG. 1 are stopped or deleted at normal times, and are started up or constructed when necessary.

The backup data store 40 has a storage area in which backup data of data in operation in the storage system 10 in the data center 1 is stored. The backup data store 40 is implemented, for example, by an object storage in a public cloud service. The storage area of the backup data store 40 is constituted by, for example, an inexpensive object storage device in order to reduce costs. For this reason, in this embodiment, the backup data stored in the storage area is stored in the backup data store 40 in a manner that makes it difficult for the host to access the backup data at high speed. A storage mode of the backup data will be described later.

The restore processing instance 30 is an example of a computer resource, and is started up by the operation management system 50 as necessary. The restore processing instance 30 executes restore processing for restoring the backup data of the backup data store 40. The restore processing instance 30 is an example of a restore computer resource, and appropriately accesses the backup data store 40 in which the backup data is stored, analyzes the backup data, restores the backup data, and finally stores the restored data in a logical volume in the virtual drive (restore processing). A plurality of restore computer resources are executed as necessary.

The cloud storage system 20 is a virtual storage system that is constructed as software using a virtual machine group and a virtual drive group of a public cloud service. The cloud storage system 20 is an example of a virtual storage system, and is started up by the operation management system 50 as necessary. The cloud storage system 20 configures an external volume 280 (to be described later) as at least one restoration source volume in which backup data can be stored as a part of a plurality of logical volumes into a virtual drive, and executes migration processing for moving the backup data from the external volume 280.

The operation management system 50 is a computer on which at least one program operates. The operation management system 50 is a system that manages the backup processing of the storage system 10 in the data center 1 and the data in operation at normal times and also controls the restore processing when necessary or in the event of a disaster. In this embodiment, although the operation management system 50 is provided in the data center 2, the operation management system 50 is not limited thereto, and may be provided in the data center 1. In this embodiment, the operation management system 50 is described as an independent element, but the operation management system 50 may be configured as a part of the cloud storage system 20 or as a part of the storage system 10 or the host.

In this embodiment, when the operation management system 50 restores the backup data to a logical volume in the virtual drive (corresponding to a logical volume 250 to be described later) by the restore processing instance 30, the operation management system 50 stores the restored backup data in an external volume (corresponding to an external volume 280 to be described later) of a high-speed virtual drive that can be accessed at a higher speed than the virtual drive, controls the restore processing instance 30 so that the restored data can be accessed, and migrates the restored data from the external volume of the high-speed virtual drive to the logical volume of the virtual drive while maintaining a state where the restored data in the external volume of the high-speed virtual drive can be accessed (migration processing).

The virtual computer resource providing service 60 is a front-end for providing a virtual machine and a virtual drive. The virtual computer resource providing service 60 provides virtual computer resources required by the data center 2, including the cloud storage system 20, in response to a request and manages billing.

The data center 2 provides a plurality of types (lineups) of virtual machines and virtual drives based on performance and cost. The virtual computer resource providing service 60 also has a function of changing the type of virtual drive used in response to a request.

The data center 1 and the data center 2 are connected to each other via a network 70. The network 70 is, for example, the Internet or a dedicated Ethernet line. The terminal 80 is, for example, a computer or a mobile terminal. A user can access the systems and services of both the data centers 1 and 2 using the terminal 80. The terminal 80 may be disposed in either the data center 1 or the data center 2.

Although not shown in the drawing, each device and the system are connected by a network in the data centers 1 and 2, and they can communicate with each other within the scope permitted by security.

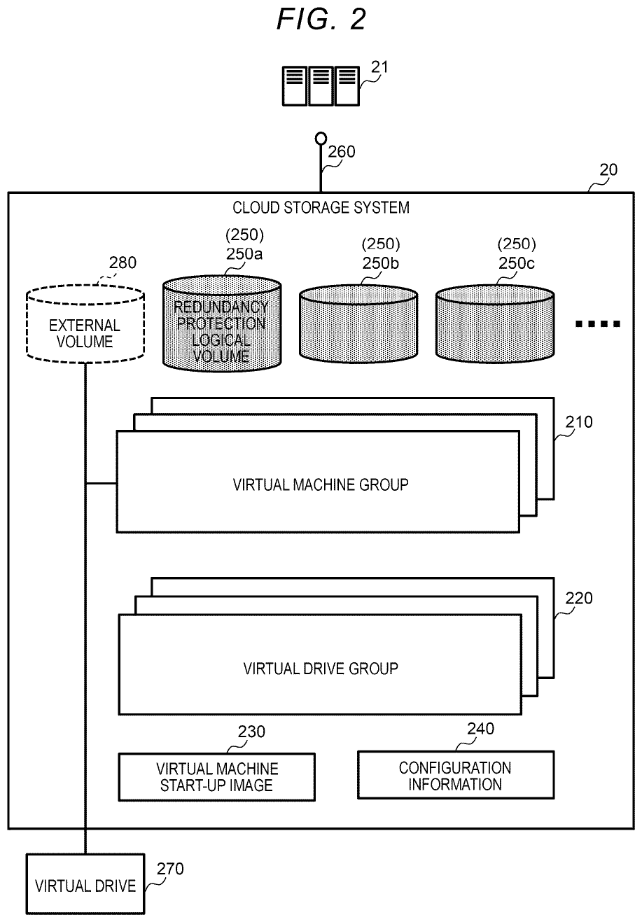

FIG. 2 is a block diagram showing a configuration example of the cloud storage system 20 shown in FIG. 1. The cloud storage system 20 is a computer environment for operating storage control software having functions that are common or similar to those of the storage system 10 described above. The cloud storage system 20 includes a virtual machine group 210, a virtual drive group 220, a virtual machine start-up image 230, configuration information 240, redundancy protection logical volumes 250a, 250b, and 250c (hereinafter collectively referred to as logical volumes 250) provided by controlling them, a host connection interface (I/F) 260, an external virtual drive 270, and the external volume 280 that presents data of the external virtual drive 270 as a logical volume.

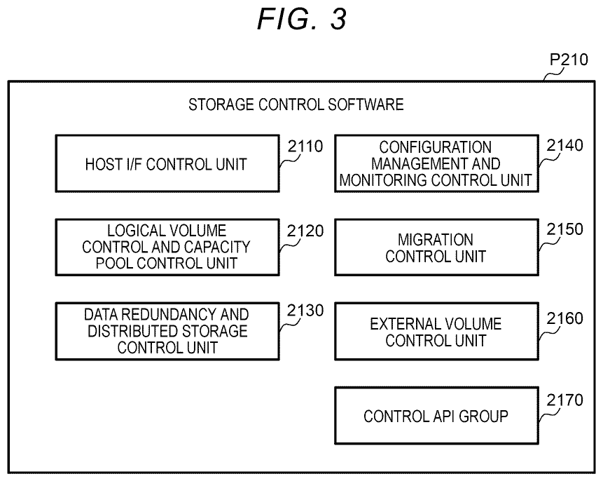

The virtual machine group 210 is constituted by a virtual computer provided by the data center 2, and is referred to as a so-called storage controller in which storage control software operates using a central processing unit (CPU) and a memory of the virtual computer. The storage control software will be described later in FIG. 3.

The virtual drive group 220 is a virtual drive (hereinafter collectively referred to as a “virtual drive”) provided by the data center 2, and is used to provide a logical drive through the storage control software operating in the virtual machine group 210.

A plurality of types (lineups) of virtual drives with different costs and performance are prepared. In the cloud storage system 20 of this embodiment, it is assumed that standard solid state drives (SSDs: hereinafter collectively referred to as “standard SSDs”) are used.

The virtual machine start-up image 230 is a machine image that includes an operating system (OS) and storage control software for starting up and operating the virtual machine group 210.

The configuration information 240 is an area in which various setting information, reference information, operation logs, and the like for the operation of the cloud storage system 20 are stored, and is managed by, for example, a database.

The logical volume 250 is a logical capacity resource that is provided through the control of the virtual machine group 210, and is a logical volume configured in the virtual drive group 220. The logical volume 250 is a logical capacity unit recognized by the host. Data stored in the logical volume 250 is made redundant for data protection using technology such as redundant array of independent disks (RAID) or Erasure Coding.

The host I/F 260 is an interface through which the host can access the logical volume 250 or the external volume 280. The host I/F 260 is provided such that a logical volume can be identified, for example, by an internet protocol (IP) address and an internet small computer system interface (isCSI) name or the like. There may be a plurality of host I/Fs 260, and the host I/Fs 260 may have a security function so that only an arbitrary host can recognize or access the logical volume.

The external virtual drive 270 is a virtual drive provided through the virtual computer resource providing service 60. The external virtual drive 270 is an individual drive separate from the virtual drive group 220 that constitute the logical volume 250. In this embodiment, the external virtual drive 270 is collectively referred to as the “external virtual drive 270” to be distinguished from the virtual drive group 220 in the cloud storage system 20. There may be a plurality of external virtual drives 270.

The external volume 280 is a volume that has been virtualized so that data can be accessed by a host, similar to the logical volume 250, using functions of storage control software to be described below. The external volume 280 is an example of a high-speed virtual drive that can be accessed at a higher speed than the virtual drive in which the logical volume 250 is configured. Similarly to the external virtual drive 270, a plurality of external volumes 280 can be configured.

FIG. 3 is a block diagram showing a configuration example of storage control software P120 of the cloud storage system 20 shown in FIG. 1. The storage control software P120 is included in the virtual machine start-up image 230 and is executed using the central processing unit (CPU) and the memory of the virtual machine group 210.

The storage control software P120 includes a host I/F control unit 2110, a logical volume control and capacity pool control unit 2120, a data redundancy and distributed storage control unit 2130, a configuration management and monitoring control unit 2140, a migration control unit 2150, an external volume control unit 2160, and a control API group 2170.

The host I/F control unit 2110 is a control program that processes I/O requests received from the host via the host I/F 260. The host I/F control unit 2110 performs control so that, throughout the execution of the migration processing, a first storage area of the external volume 280, which is an example of a restoration source volume to be subjected to migration processing, does not overlap a second storage area to be subjected to data writing for the external volume 280.

The logical volume control and capacity pool control unit 2120 is a program that processes data read and write access from the logical volume in response to requests received from the host, and manages free storage capacity held by the cloud storage system 20 as a capacity pool.

The data redundancy and distributed storage control unit 2130 is a program that performs redundancy processing for address conversion, data compression, and data protection, and the like with respect to access to the logical volume, and controls the data stored in the virtual drive group 220.

The configuration management and monitoring control unit 2140 is a program that reflects the configurations and setting information of the host I/F, the logical volume, and the virtual drive group 220 in the configuration information 240, and controls monitoring of the usage status of the CPU, the memory, the network, and the like as well as the health status of the virtual machine group 210 and the virtual drive group 220.

The configuration management and monitoring control unit 2140 is an example of a configuration control unit, and configures the logical volume 250 as at least one restoration destination volume in a virtual drive as a part of a plurality of logical volumes.

The migration control unit 2150 is a control program that controls processing of copying (that is, migrating a volume serving as an access destination of a host) the restored data from the external volume 280 to the logical volume 250 (hereinafter also referred to as “migration processing”) while continuing input/output processing with respect to the host. In this control, an access destination volume is internally switched from the external volume 280 to the logical volume 250 after the migration processing is completed, without making the host aware that the access destination has changed. The migration processing can be executed simultaneously for a plurality of pairs, and the target may be the external volume instead of the logical volume.

The external volume control unit 2160 is a control program that configures the external volume 280 that can be connected to the external virtual drive 270 via the virtual machine group 210 and treated in the same manner as the logical volume 250. A plurality of external volumes 280 can be configured.

The control API group 2170 is an interface program for controlling instructions and responses received from the operation management system 50 and the terminal 80.

The overview of the system configuration example of the data center 2 according to this embodiment is as described above, and an operation management method according to this embodiment will be described. First, as described above, the data center 2 includes the backup data store 40 that stores backup data, and the restore processing instance 30 as an example of a restore computer resource that analyzes the backup data and restores the data. In this operation management method, the operation management system 50 performs an access control step of, when restoring the backup data to the logical volume 250 in the virtual drive, storing the restored backup data in the external volume 280 of the high-speed virtual drive that can be accessed at a higher speed than the virtual drive, and controlling the restore processing instance 30 so that the restored data can be accessed, and a migration processing step of migrating the restored data from the external volume 280 of the high-speed virtual drive to the logical volume 250 of the virtual drive while maintaining an accessible state to the restored data in the external volume of the high-speed virtual drive. A management mode of the backup data in the backup data store 40 will be further described below. The backup data store 40 has the following management mode, and thus, as described above, it is difficult to perform high-speed access from the host as it is.

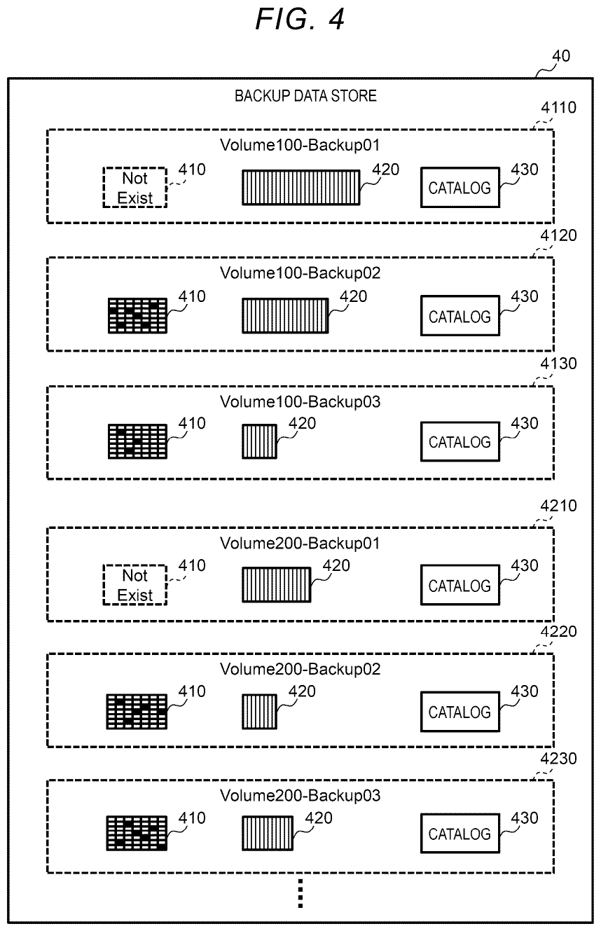

FIG. 4 is a block diagram showing a configuration example of the backup data store 40 shown in FIG. 1. The backup data store 40 includes a plurality of management areas referred to as “buckets”. In the example shown in the drawing, there are provided a Volume100-Backup01 bucket 4110 that stores a first generation backup of a Volume100, a Volume100-Backup02 bucket 4120 that stores a second generation backup of the Volume100, and a Volume100-Backup03 bucket 4130 that stores a third generation backup of the Volume100. Similarly, there are provided a Volume200-Backup01 bucket 4210, a Volume200-Backup02 bucket 4220, and a Volume200-Backup03 bucket 4230, which store first, second, and third generations of a Volume200, respectively. In the following description, the above-described various buckets are also collectively referred to simply as “buckets” unless a specific type of bucket is mentioned.

The Buckets 4110 to 4230 store a set of backup data (hereafter referred to as a “backup data set”) for restoring the volumes of the corresponding generations. The backup data set includes a differential bitmap 410 indicating whether backup has been performed for each management block size on the volume, a data block group 420 that stores backed-up blocks with forward packing, and a backup catalog 430 in which configuration information such as an identification number of a backup source volume, a device number, a capacity, the date and time of backup, and a parent-child relationship between incremental backup generations is recorded.

There is no differential bitmap 410 in the Volume100-Backup01 bucket 4110 and the Volume200-Backup01 bucket 4210, which means that the backup is not an incremental backup, but a full backup that covers the entire capacity of the volume.

In the following description, backup data for each volume stored in the backup data store 40 may be referred to as a “restore volume”, but this is synonymous.

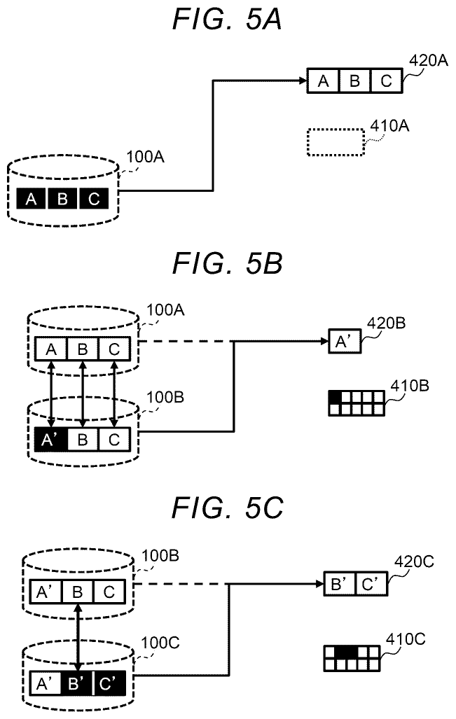

FIGS. 5A to 5C are diagrams schematically showing an example of a state where backup data of each volume is created. The backup is performed, for example, by a cloud backup function built into the storage system 10.

FIG. 5A shows the state of a first generation backup (full backup) of a volume. The volume is in a state 100A in which there are blocks indicated as “A”, “B”, and “C”. Through the full backup, a data block group 420A that stores “A”, “B”, and “C” is stored in the backup data store 40. Since this is a full backup, a differential bitmap 410A is empty (that is, no data has been created).

FIG. 5B shows an example of the state of a second generation backup (incremental backup) of a volume. The volume is in a state 100B where the block “A” has been rewritten to “A′” from the previous state 100A. Through the incremental backup, a data block group 420B that stores only the changed block “A′” is created in the backup data store 40. In addition, a differential bitmap 410B indicating the storage location of an updated block is created.

FIG. 5C is a diagram showing an example of the state of a third generation backup (incremental backup) of a volume. The volume is in a state 100C, where the blocks “B” and “C” have been rewritten to “B′” and “C′” respectively from the previous state 100B. Through the incremental backup, a data block group 420C that stores the changed blocks “B′” and “C′” is created in the backup data store 40. In addition, a differential bitmap 410C indicating the storage location of an updated block is created.

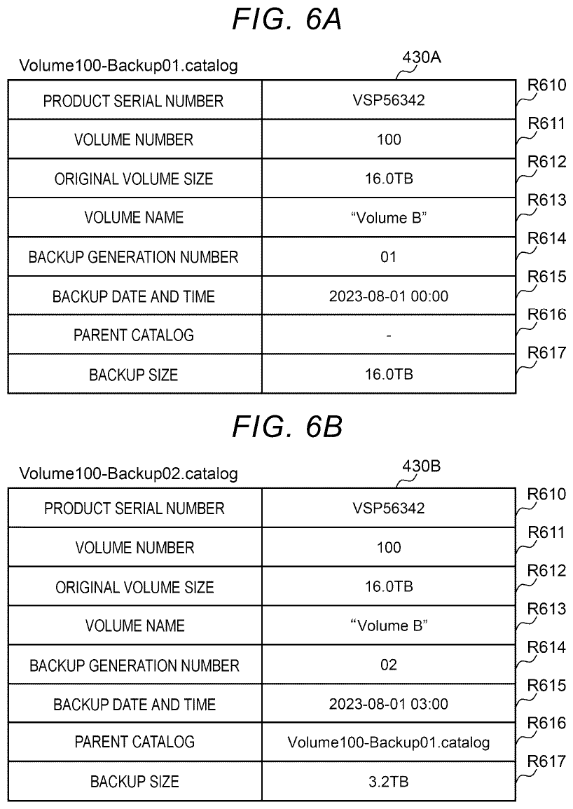

FIGS. 6A and 6B are diagrams showing examples of backup catalogs stored in the backup data store 40. FIG. 6A is a backup catalog 430A at the time of the first generation backup (full backup) of a volume.

The backup catalog 430A is stored with an object name (file name) of “Volume100-Backup01.catalog”, and information regarding a backup source serial number R610, a volume number R611, an original volume capacity R612, a volume name R613, a backup generation number R614, a backup date and time R615, parent catalog information R616 indicating a parent-child relationship at the time of an incremental backup, and a backup capacity R617 is recorded in the backup catalog 430A.

In the example shown in FIG. 6A, the backup source serial number is “VSP56432”, the volume number is “100”, the original volume capacity is “16.0 TB”, the volume name is “Volume B”, the backup generation is “Generation 01”, and the backup date and time is “2023 Aug. 1 00:00”, and since this is the first full backup, there is no parent catalog showing a parent-child relationship of backup, and a backed-up capacity is “16.0 TB”.

FIG. 6B shows a backup catalog 430B at the time of the second generation backup (incremental backup) of the volume. The backup catalog 430B is stored with an object name (file name) of “Volume100-Backup02.catalog”.

The backup source serial number R610, the volume number R611, the original volume capacity R612, the volume name R613, the backup generation number R614, the backup date and time R615, the parent catalog information R616 indicating a parent-child relationship at the time of an incremental backup, and the backup capacity R617 are similar to those shown in FIG. 6A, and thus the description thereof will be omitted.

In the example shown in FIG. 6B, the backup source serial number is “VSP56432”, the volume number is “100”, the original volume capacity is “16.0 TB”, the volume name is “Volume B”, the backup generation is Generation 02, and the backup date and time is 2023 Aug. 1 03:00. Furthermore, in the example shown in FIG. 6B, since it is an incremental backup, it is indicated that there is Volume100-Backup01. catalog, that is, the backup catalog 430A as a parent catalog showing a parent-child relationship of backup.

Thus, it can be understood that, when restoring the backup, the full backup of 430A, which is a parent backup, is required to be restored first. In addition, a backup size is 3.2 TB.

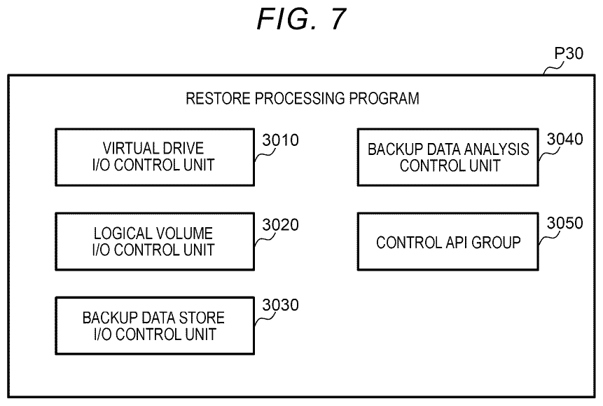

FIG. 7 is a block diagram showing a configuration example of a restore processing program P30. The restore processing program P30 is a program group that operates using the CPU and memory on the restore processing instance 30. The restore processing program P30 includes a virtual drive I/O control unit 3010, a logical volume I/O control unit 3020, a backup data store I/O control unit 3030, a backup data analysis control unit 3040, and a control API group 3050.

The virtual drive I/O control unit 3010 is a program that mounts a single virtual drive and reads and writes block data. The virtual drive is also used as the external virtual drive 270 shown in FIG. 2.

The logical volume I/O control unit 3020 is a program that is connected to the cloud storage system 20, mounts a logical volume, and reads and writes block data.

The backup data store I/O control unit 3030 is a program that reads and writes the backup data set of the backup data store 40.

The backup data analysis control unit 3040 is a program that specifies a parent-child relationship of full backup and incremental backup based on the backup catalog 430, constructs processing steps required to restore a target generation, and controls the writing of block data to a virtual drive of a restore destination and an appropriate address of a logical volume while referring to the differential bitmap 410.

The control API group 3050 is an interface program for controlling instructions and responses received from the operation management system 50 and the terminal 80.

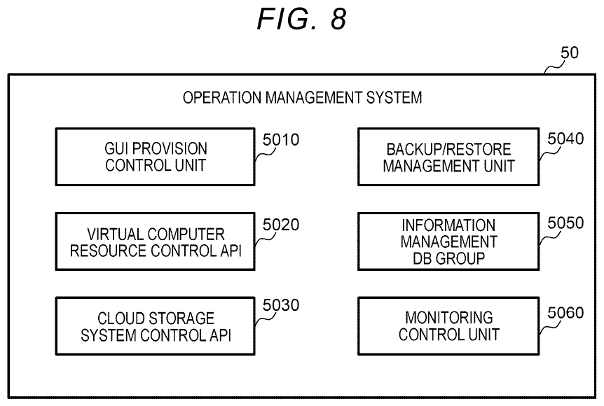

FIG. 8 is a block diagram showing a configuration example of the operation management system 50 shown in FIG. 1. The operation management system 50 includes a graphic user interface (GUI) provision control unit 5010, a virtual computer resource control API 5020, a cloud storage system control API 5030, a backup/restore management unit 5040, an information management DB group 5050, and a monitoring control unit 5060.

The GUI provision control unit 5010 is a program for providing a graphical user interface (GUI) for a user to operate the terminal 80.

The virtual computer resource control application programming interface (API) 5020 is a program that operates an API of a computer resource provided by the virtual computer resource providing service 60. For example, the virtual computer resource control API 5020 requests the virtual computer resource providing service 60 to create a virtual drive having a predetermined capacity, or starts up the virtual machine group 210 that constitutes the cloud storage system 20.

The cloud storage control application programming interface (API) 5030 is a program for giving an instruction to the storage control software P120 that operates in the cloud storage system 20. The cloud storage system control API 5030 gives instructions for, for example, creating the logical volume 250 and executing migration processing.

The backup/restore management unit 5040 is a program for performing management of an access destination uniform resource locator (URL) and an access right of the backup data store 40, management of a backup schedule of the storage system 10, and management of device information of a restore destination. The backup/restore management unit 5040 also starts the restore processing instance 30 and gives an instruction for restoration to a logical volume or a virtual drive. In this embodiment, when restoring backup data to the logical volume 250 in a virtual drive, the restore processing instance 30 stores the restored backup data to the external volume 280 of the high-speed virtual drive that can be accessed at higher speed than the virtual drive, and performs control such that the restored data can be accessed by the host. The migration control unit 2150 described above migrates the restored data from the external volume of the high-speed virtual drive to the logical volume of the virtual drive while maintaining a state where the restored data can be accessed in the external volume of the high-speed virtual drive.

The information management DB group 5050 is a database group that manages various data required for the operation management system 50 to perform control.

The monitoring control unit 5060 is a program that acquires various information on the storage system 10 and the restore processing instance 30 which are to be subjected to management and periodically monitors them.

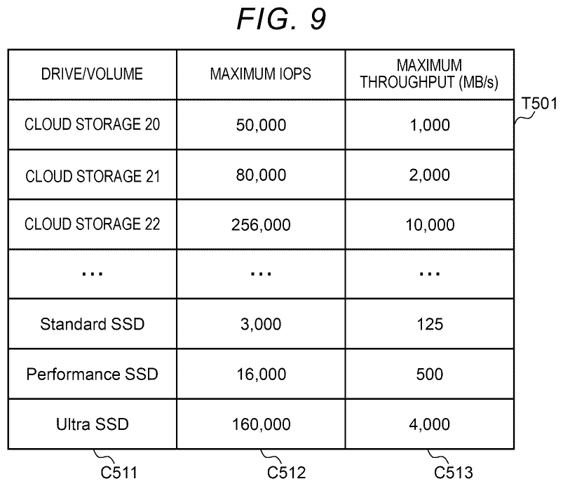

FIG. 9 is a diagram showing a configuration example of a performance management table T501 included in the information management DB group 5050 shown in FIG. 8. The performance management table T501 is an example of a performance management table, and is a table that manages information on the performance of a plurality of virtual drives, including a normal virtual drive that can be used in the data center 2 and at least one high-speed virtual drive that can be accessed at higher speed than the normal virtual drive (hereinafter, a virtual drive that can be accessed at the highest speed among the high-speed virtual drives is also referred to as a “highest-speed virtual drive”). Furthermore, the performance management table T501 is a table that also manages information on the performance of the cloud storage system 20. The virtual drive is, for example, a solid state drive (SSD).

The performance management table T501 manages a type C511, maximum input/output per second (IOPS) performance C512, and maximum throughput performance C513 of the cloud storage system 20 and each virtual drive. The unit of information of the maximum throughput performance C513 is, for example, MB/s. It is possible to acquire information regarding the performance of each virtual drive that can be used in the data center 2 by referring to the performance management table T501.

The above-described configuration management and monitoring control unit 2140 is an example of a configuration control unit, and selects the highest-speed virtual drive from among the plurality of virtual drives as an example of a high-speed virtual drive with reference to the performance management table T501, and adopts the highest-speed virtual drive instead of a virtual drive to be used. In this embodiment, when there are a plurality of high-speed virtual drives, a virtual drive that has lower performance but is faster than the highest-speed virtual drive may be selected from among the plurality of high-speed virtual drives.

In the example of FIG. 7 described above, it can be understood that the cloud storage system 20 has a maximum IOPS of 50,000 and a throughput of 1,000 MB/s, a cloud storage system “No. 21” has a maximum IOPS performance of “80,000” and a maximum throughput of “2,000 MB/s”, and a cloud storage system “No. 22” has a maximum IOPS performance of “256,000” and a maximum throughput of “10,000 MB/s”.

In addition, a “Standard SSD” has a maximum IOPS performance of “3,000” and a maximum throughput of “125 MB/s”. Similarly, a “Performance SSD” has a maximum IOPS performance of “16,000” and a maximum throughput of 500 MB/s, and an Ultra SSD has a maximum IOPS performance of “160,000” and a maximum throughput of “4,000 MB/s”.

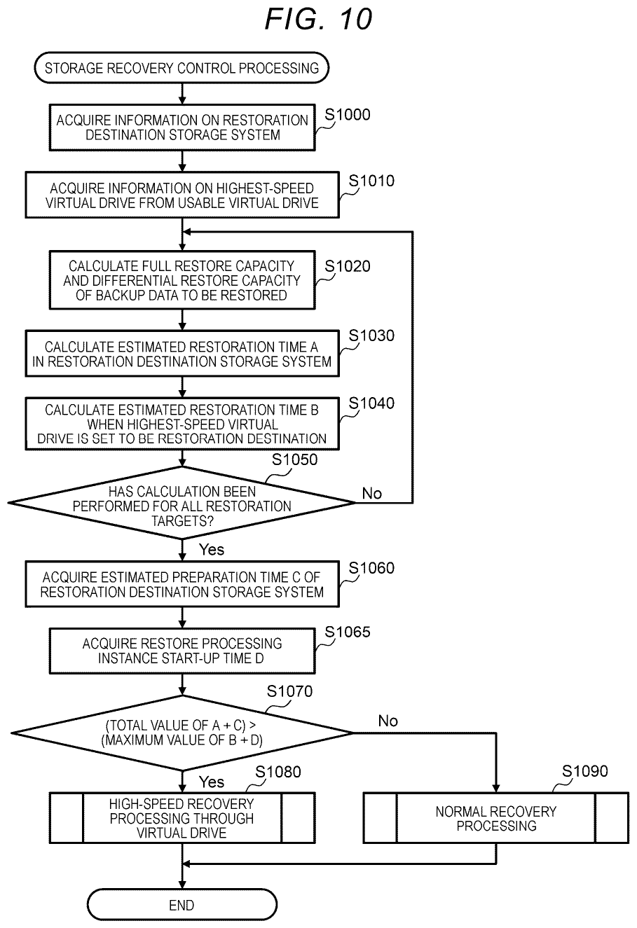

FIG. 10 is a flowchart showing an example of procedures of storage recovery control processing. This storage recovery control processing is executed by the operation management system 50 in response to an instruction received from the terminal 80, a determination made by the operation management system 50, or the like.

First, the backup/restore management unit 5040 of the operation management system 50 acquires performance information of the cloud storage system 20 serving as a restoration destination with reference to the performance management table T501 (see FIG. 9) (step S1000). In FIG. 10, the cloud storage system 20 serving as a restoration destination to a “restoration destination storage system”.

Next, the backup/restore management unit 5040 of the operation management system 50 acquires information on the performance of the highest-speed virtual drive that can be accessed at higher speed than the logical volume of the cloud storage system 20 with reference to the performance management table T501 (step S1010).

The backup/restore management unit 5040 of the operation management system 50 refers to the backup catalog 430 stored in the backup data store 40. The backup/restore management unit 5040 of the operation management system 50 calculates each total value of the amount of full backed-up data (that is, a full restore capacity) and the amount of incrementally backed-up data (that is, an incremental restore capacity) which are required to restore a target generation of a volume to be recovered (step S1020).

For example, in the example shown in FIG. 4, when restoring the third generation of the volume, the backup capacity of the first generation serving as a full restore becomes a full restore capacity, and the sum of the backup capacities of the second and third generations serving as an incremental restore becomes an incremental restore capacity.

Next, the backup/restore management unit 5040 of the operation management 50 calculates an estimated system restoration time A in the cloud storage system 20 which is a restoration destination by using the previously calculated values of the restore capacities (full restore capacity and incremental restore capacity) (step S1030).

For example, the estimated restoration time A is obtained as follows. First, for the restoration of a full restore, which is generally a sequential write, a required full restoration time (minutes) is calculated by calculating “full restore capacity (MB)÷throughput (MB/s)÷60 s”.

Next, for an incremental restore which is generally a random write, the number of restore blocks (that is, the number of restore IOs) is obtained by calculating “incremental restore capacity (MB)÷management block size (MB)”. Furthermore, a required incremental restoration time (minutes) is obtained by calculating “the number of restore IOs÷IOPS performance (IO/s)÷60 s”. In this embodiment, the estimated restoration time A can be calculated from the sum of the required full restoration time and the required incremental restoration time. The above-described calculation method is just one example, and the estimated restoration time A may also be obtained by a different method such as estimation using machine learning.

Next, the backup/restore management unit 5040 of the operation management system 50 calculates an estimated restoration time B when the highest-speed virtual drive is used as a restoration destination (step S1040). The estimated restoration time B can be obtained, for example, by performing the same calculation as that for the estimated restoration time A. The estimated restoration time B may be calculated using a method different from that: for the estimated restoration time A.

The backup/restore management unit 5040 of the operation management system 50 checks whether calculation has been performed for all restoration targets (step S1050). When there are still other restoration target volumes (step S1050: No), the backup/restore management unit 5040 returns to step S1020 to repeat the processing. This is a case, for example, where the Volume200 is also to be restored in addition to the Volume100 in FIG. 4.

On the other hand, when there are no other restoration target volumes (step S1050: Yes), the backup/restore management unit 5040 of the operation management system 50 acquires an estimated preparation time C (step S1060) of the cloud storage system 20 which is a restoration destination and a restore processing instance start-up time D (step S1065).

The estimated preparation time C is a time required from when the virtual machine group 210 is started up until when a logical volume to be used for restoration is prepared through the creation of the virtual drive group 220 and the creation of a capacity pool. The estimated preparation time C can be calculated, for example, from a construction time per unit of each phase, which is stored in advance in the information management DB group 5050 the operation management system 50. Alternatively, another method, such as defining the estimated preparation time C as a fixed value, may be used.

The restore processing instance start-up time D is a time required from when the restore processing instance 30 is started up until when it becomes possible to use the restore processing program P30 that starts to operate in response to an instruction. The restore processing instance start-up time D is generally expected to be constant, and thus the operation management system 50 may have the restore processing instance start-up time D as a fixed value, or another method such as acquiring the restore processing instance start-up time D with reference to another virtual machine start-up time of the data center 2 may be used.

Next, the backup/restore management unit 5040 of the operation management system 50 compares which is faster between a case where the cloud storage system 20 executes restore processing by using a virtual drive to be used and a case where the cloud storage system 20 executes restore processing by using the highest-speed virtual drive (step S1070). That is, the backup/restore management unit 5040 compares “Estimated restoration times of all volumes in cloud storage system 20 (total value of A)+Estimated preparation time C of cloud storage system 20” with “Estimated restoration time of volume that takes longest restoration time when all volumes are restored in parallel on virtual drive (maximum value of B)+Restore processing instance start-up time D”.

This is because, as shown in FIG. 7, the maximum performance of the cloud storage system 20 depends on the system performance, and thus a total required time does not change even when the volumes are restored in parallel or sequentially. On the other hand, a virtual drive has the performance of a single drive, and thus, when the number of virtual drives corresponding to the number of volumes are prepared in parallel, a required time is limited by a volume that takes the longest restoration time.

When the backup/restore management unit 5040 of the operation management system 50 determines, based on a result of the above comparison (step S1070), that the highest-speed virtual drive can execute restore processing at higher speed in a shorter time than the virtual drive to be used (step S1070: Yes), restore processing using the highest-speed virtual drive (hereinafter also collectively referred to as “high-speed recovery processing”) is executed (step S1080), and the processing is ended. The high-speed recovery processing using the highest-speed virtual drive will be described later.

On the other hand, when the backup/restore management unit 5040 of the operation management system 50 determines that the virtual drive to be used is faster in a shorter time or is similar to the highest-speed virtual drive (step S1070: No), that is, when it is determined that high-speed recovery processing cannot be performed, restore processing using the virtual drive to be used (normal recovery processing) is executed (step S1090), and the processing is ended. The normal recovery processing will be described later.

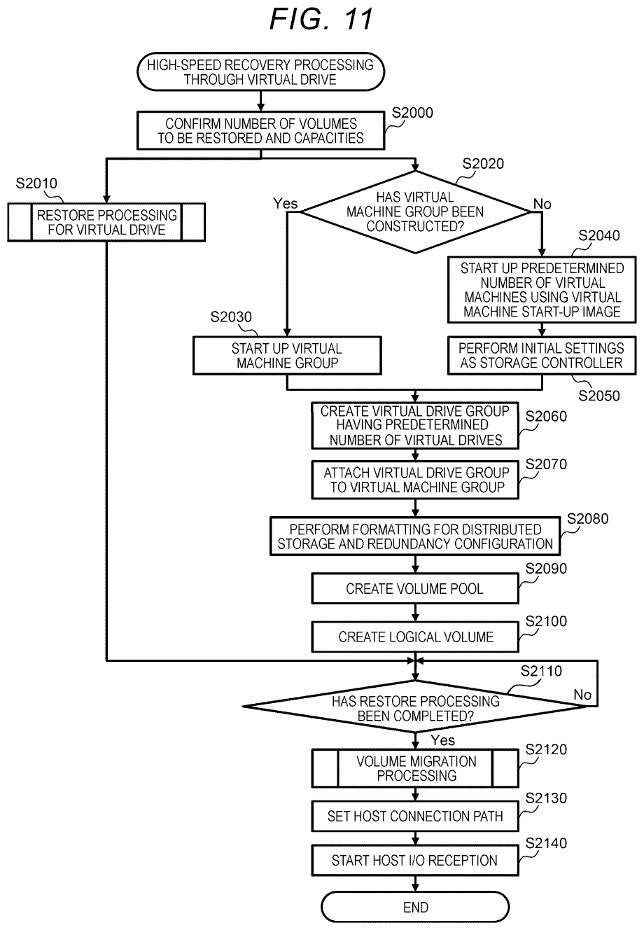

FIG. 11 is a flowchart showing an example of procedures of high-speed recovery processing using a virtual drive. This high-speed recovery processing is executed by the operation management system 50 when it is determined that a required recovery time can be shortened when performing restoration using the highest-speed virtual drive, based on the branching of step S1080 in FIG. 8.

The backup/restore management unit 5040 of the operation management system 50 first confirms the number of volumes to be restored from backup data and capacities (step S2000).

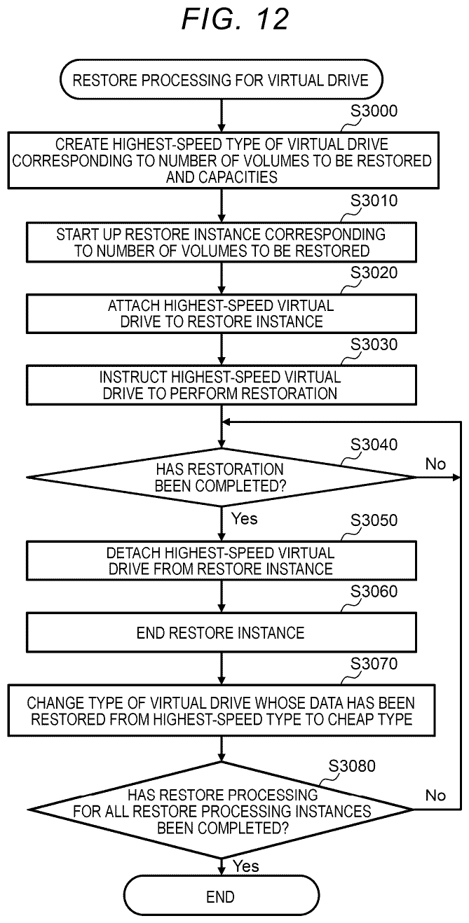

Next, the backup/restore management unit 5040 of the operation management system 50 creates a new virtual drive based on the number of restoration target volumes and their respective capacities and starts restore processing (step S2010). Details of the restore processing for a virtual drive will be described later with reference to FIG. 12.

The backup/restore management unit 5040 of the operation management system 50 executes the following steps S2020 to S2100 to perform preparation so that the cloud storage system 20 can be used by the host, in parallel with the restore processing for the virtual drive (step S2010).

The backup/restore management unit 5040 of the operation management system 50 checks whether the virtual machine group 210 has been constructed as a storage controller (step S2020), and when the virtual machine group 210 has been constructed (step S2020: Yes), the backup/restore management unit 5040 starts the virtual machine group 210 (step S2030). On the other hand, when the virtual machine group 210 has not been constructed (step S2020: No), the backup/restore management unit 5040 of the operation management system 50 requests the virtual computer resource providing service 60 to allocate a predetermined number of virtual machines, then starts the virtual machine group 210 using the virtual machine start-up image 230 (step S2040) and performs initial settings of the storage control software P120 (step S2050). The initial settings include, for example, setting of a system name, setting of a management subnet, setting of an administrator, and authentication of a license.

Next, the backup/restore management unit 5040 of the operation management system 50 creates the virtual drive group 220 having a predetermined number of virtual drives with capacities (step S2060) and attaches it to the virtual machine group 210 (step S2070).

Thereafter, the backup/restore management unit 5040 of the operation management system 50 instructs the storage control software through the cloud storage system control API 5030 to perform formatting for distributed storage and redundancy configuration on the virtual drive group 220 (for example, an RAID format) (step S2080), construct a capacity pool (step S2090), and create a logical volume 250 based on the number of volumes and the capacities confirmed in step S2000 (step S2100).

The backup/restore management unit 5040 of the operation management system 50 checks whether the restore processing for the virtual drive performed in step S2010 has been completed (step S2110), and when the restore processing has not been completed (step S2110: No), the backup/restore management unit 5040 waits until the restore processing is completed.

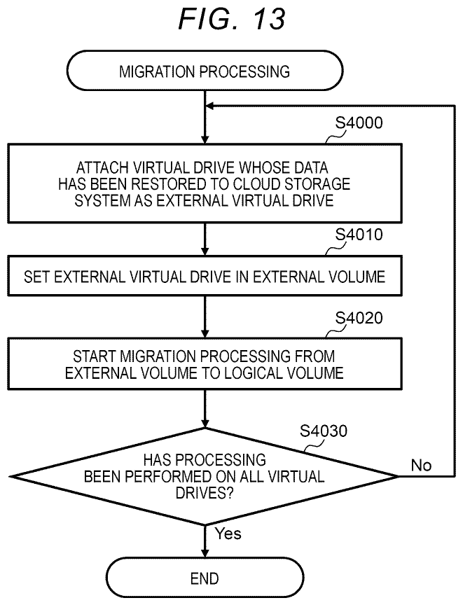

When the restore processing for the virtual drive has been completed (step S2110: Yes), the backup/restore management unit 5040 of the operation management system 50 instructs the storage control software P120 to attach the virtual drive to the cloud storage system 20 as the external virtual drive 270 and start migration processing (step S2120). Details of the migration processing will be described later in FIG. 13.

When the backup/restore management unit 5040 of the operation management system 50 starts migration processing, the backup/restore management unit 5040 sets a host connection path so that the host can access the logical volume 250 through the host I/F 260 (step S2130). The migration processing can be executed by receiving an I/O request from the host. In the operation management system 50, the backup/restore management unit 5040 instructs the storage control software P120 to start processing for receiving an I/O access from the host (step S2140), and then ends this processing.

FIG. 12 is a flowchart showing an example of procedures of the restore processing for the virtual drive in step S2010 in FIG. 11. First, the backup/restore management unit 5040 of the operation management system 50 creates a plurality of highest-speed virtual drives according to the number of volumes serving as a target of the restore processing and their capacities, based on the information acquired in step S2000 in FIG. 11 (the number of volumes to be restored from backup data and their respective capacities) (step S3000). For example, in this embodiment, it is assumed that an Ultra SSD is used from the performance management table T501 shown in FIG. 9.

The backup/restore management unit 5040 of the operation management system 50 starts up a plurality of restore processing instances 30 according to the number of volumes to be restored (step S3010) and attaches highest-speed virtual drives to the restore processing instances 30 (step S3020).

Next, the backup/restore management unit 5040 of the operation management system 50 instructs the restore processing program P30 of each restore processing instance 30 to restore each piece of designated backup data to the highest-speed virtual drive (step S3030). Thereby, the restore processing instances 30 operate in parallel by the number of restore volumes to perform restore processing. When the restore processing instance 30 has a sufficient processing ability (computational performance and transfer bandwidth), restore processing for a plurality of highest-speed virtual drives may be assigned to one restore processing instance 30.

The backup/restore management unit 5040 of the operation management system 50 checks whether the processing of each restore processing instance 30 has been completed (step S3040), and when there is a restore processing instance 30 for which the restore processing has been completed (step S3040: Yes), the backup/restore management unit 5040 detaches the highest-speed virtual drive from the restore processing instance 30 (step S3050) and ends the restore processing instance 30.

The highest-speed virtual drive for which the restore processing has been completed requests the virtual computer resource providing service 60 to change the type of the virtual drive from a highest-speed type to a cheaper type by the operation management system 50 in order to reduce the subsequent pay-per-use costs. For example, the type is changed to the same “Standard SSD” as that used in the cloud storage system 20 (step S3070).

The backup/restore management unit 5040 of the operation management system 50 checks whether the restore processing for all of the restore processing instances 30 has been completed (step S3080), and when there is a restore processing instance 30 for which the restore processing has not been completed (step S3080: No), the backup/restore management unit 5040 continues monitoring (step S3040). On the other hand, when the restore processing for all of the restore processing instances 30 has been completed (step S3080: Yes), the processing ends, and the processing returns to the processing in FIG. 9 described above and is then executed.

FIG. 13 is a flowchart showing an example of procedures of the migration processing as step S2120 shown in FIG. 11. The backup/restore management unit 5040 of the operation management system 50 attaches the virtual drive whose data has been restored in the restore processing shown in FIG. 12 to the cloud storage system 20 as the external virtual drive 270 (step S4000).

The backup/restore management unit 5040 of the operation management system 50 instructs the storage control software P120 to perform setting so that the external virtual drive 270 is used instead of the external volume 280 (step S4010).

Thereafter, the backup/restore management unit 5040 of the operation management system 50 starts migration processing between the external volume 280 and the logical volume 250 having the same capacity as that of the external volume 280 (step S4020). The migration processing is executed in a background.

The backup/restore management unit 5040 of the operation management system 50 checks whether the same processing has been performed on all of the virtual drives with restored data which are created in step S2010 (step S4030), and when there are still virtual drives that have not yet been processed (step S4030: No), the backup/restore management unit 5040 similarly repeats steps S4000 to S4020. On the other hand, when the backup/restore management unit 5040 of the operation management system 50 has started migration processing on all of the virtual drives with restored data (step S4030: Yes), the backup/restore management unit 5040 ends the migration processing and returns to the processing in FIG. 9 to execute it.

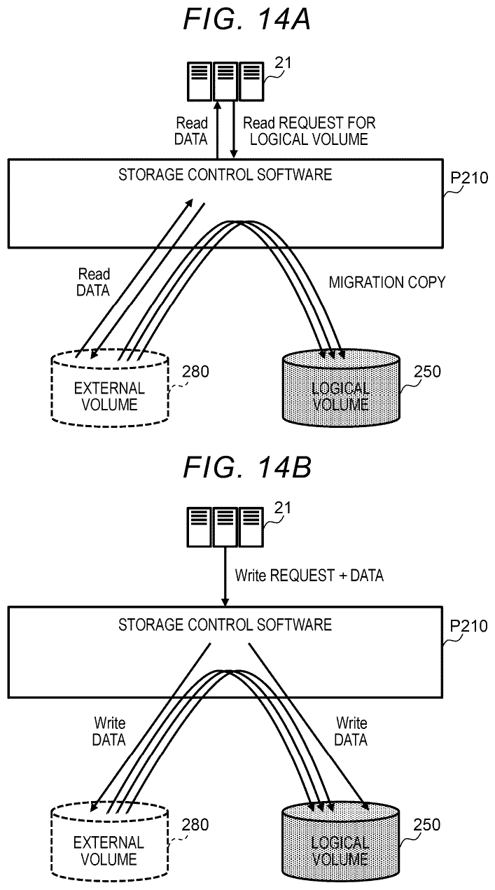

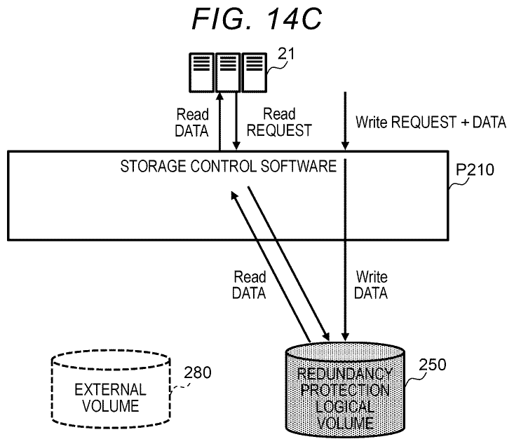

FIGS. 14A to 14C each show an example of a state where the storage control software P120 performs migration processing in a background without stopping input/output processing with respect to the host. That is, FIGS. 14A to 14C show a state where control is performed when input/output processing with respect to the host is started to be received for the logical volume 250 in step S2140 shown in FIG. 11.

FIG. 14A shows an example of a case where the host has made a read I/O request to the logical volume 250 during the execution of migration processing. Data restored from backup data is stored in the external volume 280. The data is read out sequentially by the storage control software P120 and copied to the logical volume 250.

In the meantime, when the host has made a read request to the logical volume 250, the storage control software P120 reads data from the external volume 280 which is a copy source and responds to the host, thereby continuing the migration processing in the background while providing an access to the restored data.

FIG. 14B shows an example of a case where the host has made a write I/O request to the logical volume 250 during the execution of migration processing. As described above, the data of the external volume 280 is sequentially read by the storage control software P120 and copied to the logical volume 250.

In the meantime, when the host has made a write request to the logical volume 250, the storage control software P120 writes data corresponding to the write request to both the external volume 280 and the logical volume 250, and thus it is possible to continue the migration processing in the background without stopping input/output processing with respect to the host.

FIG. 14C shows an example of a case where the host has made a read request or a write request to the logical volume 250 after the migration processing is completed. Since all data of the external volume 280 has been copied to the logical volume 250, the external volume 280 is no longer necessary, and all I/O requests are made to the logical volume 250.

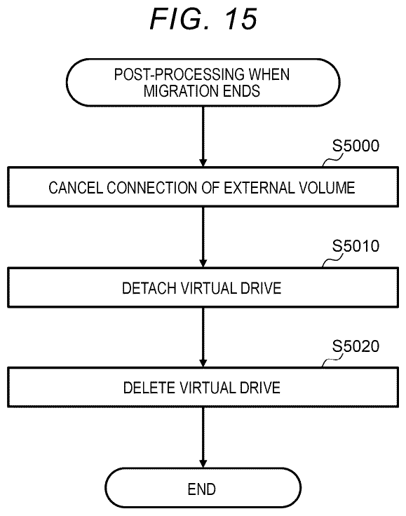

FIG. 15 is a flowchart showing an example of post-processing performed by the operation management system 50 when the migration processing performed in the background is completed.

When the migration is completed, the backup/restore management unit 5040 of the operation management system 50 disconnects the external volume 280 that is no longer being accessed (step S5000). Thereafter, the backup/restore management unit 5040 of the operation management system 50 detaches the external virtual drive 270 controlled as the external volume (step S5010), then deletes it (step S5020), and ends the processing.

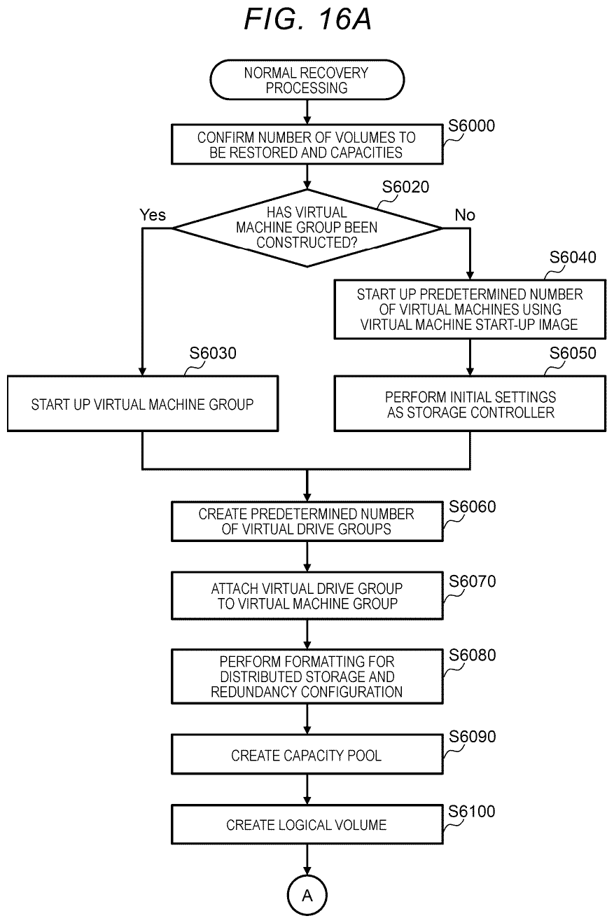

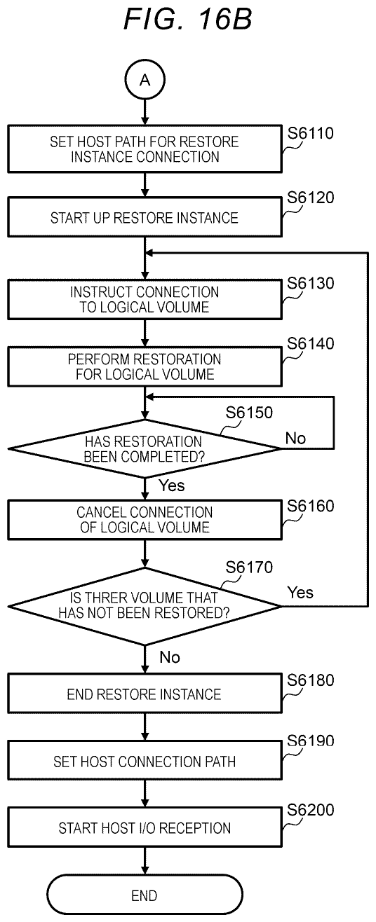

FIGS. 16A and 16B are flowcharts showing an example of normal recovery processing. This normal recovery processing is executed by the operation management system 50 when high-speed recovery processing using a virtual drive cannot be applied based on the branching of step S1070 shown in FIG. 10.

The backup/restore management unit 5040 of the operation management system 50 first confirms the number of volumes to be restored from the backup data and their respective capacities (step S6000). Next, the backup/restore management unit 5040 of the operation management system 50 performs preparation so that the cloud storage system 20 can be used by the host (steps S6020 to S6100).

The backup/restore management unit 5040 of the operation management system 50 checks whether the virtual machine group 210 has been constructed (step S6020), and when the virtual machine group 210 has been constructed (step S6020: Yes), the backup/restore management unit 5040 starts up the virtual machine group 210 (step S6030).

On the other hand, when the virtual machine group 210 has not been constructed (step S6020: No), the backup/restore management unit 5040 of the operation management system 50 requests the virtual computer resource providing service 60 to allocate a predetermined number of virtual machines, then starts up the virtual machine group 210 using the virtual machine start-up image 230 (step S6040), and performs initial settings of the storage control software P120 (step S6050). The initial settings include, for example, setting of a system name, setting of a management subnet, setting of an administrator, and authentication of a license.

Next, the backup/restore management unit 5040 of the operation management system 50 creates a predetermined number of virtual drive groups 220 having predetermined capacities (step S6060) and attaches them to the virtual machine group 210 (step S6070).

Thereafter, the backup/restore management unit 5040 of the operation management system 50 instructs the storage control software P120 through the cloud storage system control API 5030 to perform formatting for distributed storage and redundancy configuration on the virtual drive group 220 (for example, an RAID format) (step S6070), construct a capacity pool (step S6090), and create a logical volume 250 based on the number of volumes and the capacities confirmed in step S6000 (step S6100).

Thereafter, the backup/restore management unit 5040 of the operation management system 50 instructs the storage control software P120 to set a connection host path for the restore processing instance 30 to access the logical volume 250 (step S6110).

Next, the backup/restore management unit 5040 of the operation management system 50 starts up one restore processing instance 30 (step S6120). Then, the backup/restore management unit 5040 of the operation management system 50 instructs the restore processing program P30 to connect a logical volume that matches the capacity of a restore volume (backup data) to be restored to the restore processing instance (step S6130). Then, the restore processing program P30 restores the backup of a designated volume to the logical volume based on the instruction received from the backup/restore management unit 5040 of the operation management system 50.

The backup/restore management unit 5040 of the operation management system 50 waits until the restore processing program P30 completes the restore processing (steps S6150 and S6150: No). When the completion is confirmed (step S6150: Yes), the backup/restore management unit 5040 of the operation management system 50 disconnects the logical volume whose data has been restored (step S6170).

When there are any restore volumes that have not yet been restored (step S6170: Yes), the backup/restore management unit 5040 of the operation management system 50 repeats steps S6130 to S6160 until the restoration of all volumes is completed. On the other hand, when the restoration of all restore volumes has been completed (step S6160: No), the backup/restore management unit 5040 of the operation management system 50 ends the restore processing instance 30 (step S6180).

Next, the backup/restore management unit 5040 of the operation management system 50 sets a host connection path so that the host can access the logical volume 250 through the host I/F 260 (step S6190), instructs the storage control software to start processing for receiving an I/O access from the host (step S6200), and ends this processing.

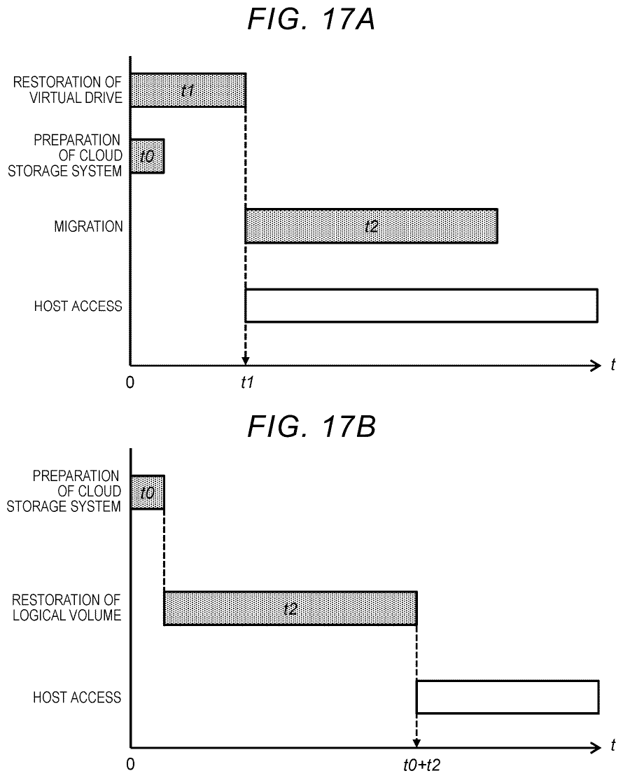

FIG. 17A is a diagram showing an example of a relationship between required times of processing in high-speed recovery processing using a virtual drive (see FIG. 9). In the example shown in the drawing, the horizontal axis represents an elapsed time.

In this embodiment, restore processing (corresponding to processing spanning time t1 shown in the drawing) by the restore processing instance 30 as an example of a restore computer resource and the configuration of the logical volume 250 by the cloud storage system 20 (corresponding to processing spanning time to shown in the drawing) are executed in parallel.

In this embodiment, the host I/F control unit 2110 restarts input/output processing with respect to the host upon the start of migration processing.

Detailed description will be given below. In this high-speed recovery processing, while restore (step S2010) for (the external volume 280 of) the virtual drive is being executed at time t1, preparation of the cloud storage system 20 (steps S2020 to S2100) is performed in parallel at time t0. Then, when the restore for (the external volume 280 of) the virtual drive is completed, migration processing (step S2120) is started from time t1, and the migration processing continues for time t2. During the migration processing, the host can access the restored data from time t1, and thus it can be understood that a time required for the host to start access is t1 (<time t2). It is clear that t1<t2 from the determination of branching in step S1070 in FIG. 10.

FIG. 17B is a diagram showing an example of a relationship between required times of processing in the normal recovery processing shown in FIG. 14. The horizontal axis represents an elapsed time. In this normal recovery processing, in order to perform directly restoration for the logical volume 250 without going through the external volume 280 of the virtual drive, first, preparation of a cloud storage (steps S6020 to S6100) is performed at time to. Thereafter, restoration for the logical volume 250 (steps S6110 to S6160) is performed at time t2, and the host's access is started after the restoration is completed. Thus, it can be understood that a time required for the host to start access is to +t2.

From comparison between FIG. 17A and FIG. 17B, it can be understood that the high-speed recovery processing (see FIG. 17A) using (the external volume 280 of) the virtual drive takes less required time to start the host's access than the normal recovery processing (see FIG. 17B) because time to and time t2 can be hidden. In this manner, according to this embodiment, it is possible to shorten a recovery time until the host can make access, and the scope of a target for which backup using this method is applicable can be expanded to logical volumes with short target recovery times.

As described above, in the operation management system 50 of the data center 2 in this embodiment, the data center 2 includes the backup data store 40 that stores backup data, and the restore processing instance 30, which is an example of a restore computer resource, analyzing the backup data and restoring the data. The operation management system 50 stores, when the backup data is restored to a logical volume in a virtual drive, the restored backup data in an external volume of a high-speed virtual drive that can be accessed at higher speed than the virtual drive, controls the restore processing instance 30 so that the host can access the restored data, and migrate the restored data from the external volume of the high-speed virtual drive to the logical volume of the virtual drive while maintaining a state where the restored data in the external volume of the high-speed virtual drive can be accessed.

In this manner, regardless of the start of the migration processing, input/output processing with respect to the host (host access) can be started immediately after a point in time when restore processing (corresponding to “restoration of the virtual drive” over time t1 shown in FIG. 17A) by the restore processing instance 30 and the configuration of the logical volume 250 (corresponding to “cloud storage preparation” over time to shown in FIG. 17A) by the cloud storage system 20 are completed, and thus it is possible to shorten a recovery time until the system is available to the host.

In the data center 2 according to this embodiment, the restore processing performed by the restore processing instance 30 and the configuration of the logical volume 250 by the cloud storage system 20 are executed in parallel (see, for example, FIG. 17A). In this manner, it is not necessary to wait until the migration processing (corresponding to “migration” shown 17A) ends in order to start input/output processing with respect to the host, and thus it is possible to restart the input/output processing with respect to the host at an earlier timing and further shorten a recovery time.

In this embodiment, the host I/F control unit 2110 is an example of an interface control unit, and restarts input/output processing with respect to the host upon the start of the migration processing. In this manner, it is possible to start the input/output processing with respect to the host without waiting for the migration processing to end.

### (2) Second Embodiment

Since a second embodiment has the same configurations and operations as those of the first embodiment, description of the same configurations and operations as those of the first embodiment will be omitted in the second embodiment, and description will be given below focusing on differences.

In the first embodiment, when a processing time can be shortened, the above-described high-speed recovery processing is performed as restore processing using highest-speed virtual drive unconditionally, but it is also conceivable that there is a margin in a target recovery time for the entire system.

Consequently, in the second embodiment, taking this into consideration, a recovery processing method and a virtual drive are selected depending on a target recovery time. The following description will be given mainly focusing on the differences from the first embodiment. Other configurations not described are the same as those in the first embodiment.

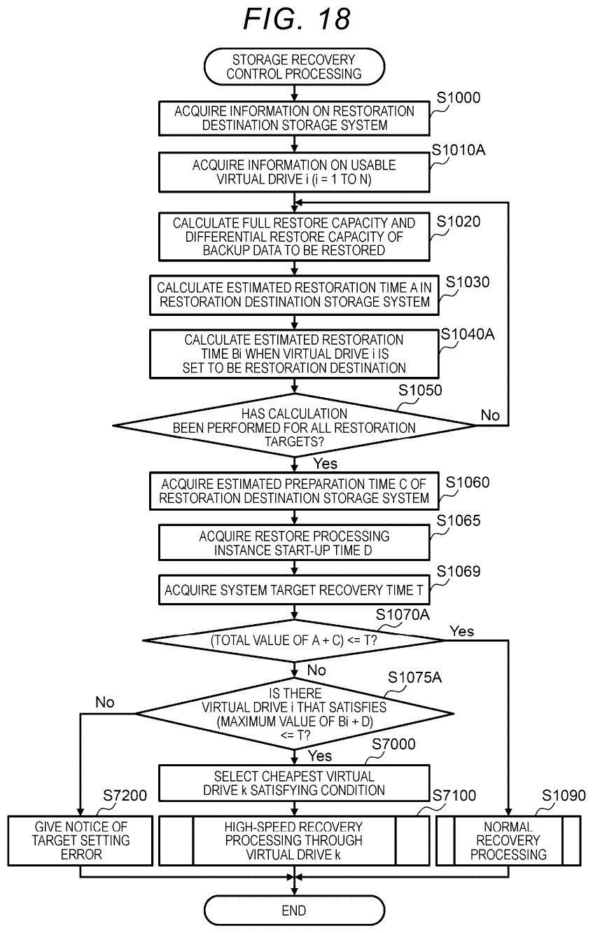

FIG. 18 is a flowchart showing an example of procedures of storage recovery control processing in the second embodiment. The storage recovery control processing is executed by an operation management system 50 in response to an instruction received from a terminal 80 or determination made by the operation management system 50, and is basically the same as FIG. 10 in the first embodiment, but some of the processes (steps S1010A, S1040A, S1069, S1070A, S1075A, S7000, S7100, S7200) are different.

A backup/restore management unit 5040 of the operation management system 50 acquires performance information of the cloud storage system 20 which is a restoration destination with reference to a performance management table T501 (see FIG. 9) in the same manner as in step S1000 of FIG. 10 (step S1000). Next, performance information of a virtual drive i that can be used in this data center is acquired with reference to the performance management table T501 (see FIG. 9) (step S1010A). In this embodiment, the performance management table T501 has three types of information on the performance of the virtual drive from “Standard SSD” to “Ultra SSD”. Thus, information when i=1 to 3 is acquired.

Next, the backup/restore management unit 5040 of the operation management system 50 refers to a backup catalog 430 stored in the backup data store 40. Furthermore, the backup/restore management unit 5040 of the operation management system 50 calculates each total value of full backed-up backup data (that is, a full restore capacity) and incrementally backed-up backup data (that is, an incremental restore capacity) required to restore a target generation of a volume to be recovered (step S1020).

The backup/restore management unit 5040 of the operation management system 50 calculates an estimated restoration time A in a cloud storage system 20 which is a restoration destination by using the previously calculated values (step S1030). Specific examples of steps S1020 and S1030 have already been described in FIG. 10, and thus the description thereof will be omitted.

Next, the operation management system 50 calculates an estimated restoration time Bi when each virtual drive i is set to be a restoration destination (step S1040A). A calculation method for the estimated restoration time Bi is the same as the calculation method for the restoration time B using the highest-speed virtual drive in step S1040 of FIG. 10, and thus the description thereof will be omitted.

The operation management system 50 checks whether calculation has been performed for all restoration targets (step S1050), and when there are other restoration target volumes (step S1050: No), the operation management system 50 returns to step S1020 and repeats the processing.

On the other hand, when there are no other restoration target volumes (step S1050: Yes), the operation management system 50 acquires an estimated preparation time C (step S1060) and a restore processing instance start-up time D (step S1065) of the cloud storage system 20 which is a restoration destination. A method of acquiring the estimated preparation time C and the restore processing instance start-up time D is the same as the processing in FIG. 10.

Thereafter, the operation management system 50 acquires a target recovery time T of the system (step S1069). Then, the operation management system 50 compares whether a time required to directly perform restoration to the cloud storage system 20, that is, “the estimated restoration time of all volumes in the cloud storage system 20 (a total value of A)+the estimated preparation time C of the cloud storage system 20”, falls within the target recovery time T (step S1070A).

As a result of the comparison, when the target recovery time T can be achieved even with direct restoration (step S1070A: Yes), the operation management system 50 performs normal recovery processing (step S1090). Details of the normal recovery processing are the same as those in the first embodiment described above (see FIG. 16), and thus the description thereof will be omitted.

On the other hand, when the target recovery time T cannot be achieved even with direct restoration (step S1070A: No), the operation management system 50 compares the target recovery time T with “an estimated restoration time of a volume that takes the longest restoration time (maximum value of Bi)+restore processing instance start-up time D when restore of all volumes is processed in parallel in the virtual drive i”, that is, in the case of performing restoration using the virtual drives i (step S1075A).

When there is no virtual drive i that satisfies a specific condition related to the target recovery time T (step S1075A: No), the operation management system 50 gives notice of a target setting error (step S7200) because recovery is not possible within the target recovery time T, and ends the processing.

On the other hand, when there are a plurality of virtual drives i that satisfy the specific condition (step S1075A: Yes), the operation management system 50 selects a high-speed virtual drive k (k ∈ i) to restore data from among the plurality of virtual drives, that is, selects a virtual drive k (k ∈ i) that satisfies the specific condition and has the lowest usage fee from among the plurality of virtual drives, based on the target recovery time T of the restoration and the performance and usage fee of the virtual drives (step S7000), and performs restore processing (high-speed recovery processing) using the virtual drive k (step S7100). In this manner, it may be possible to complete the restore processing (high-speed recovery processing) within the target recovery time T while reducing costs.

The high-speed recovery processing using the virtual drive k is equivalent to processing in which the “highest-speed virtual drive” is replaced with the “virtual drive k” in the operations of FIGS. 11 to 15 in the first embodiment, and thus illustrations and descriptions are omitted.

According to this embodiment, it is possible to reduce a recovery time until a system is accessible to a host while keeping costs down because a recovery method is switched based on the target recovery time T, and it is possible to expand the scope of a target for which backup using this method is applicable to logical volumes with short target recovery times. In addition, according to this embodiment, determination of whether the target recovery time T can be satisfied is made before the data recovery processing, and thus it is possible to perform a pre-test without incurring the costs and time required for the actual data recovery processing.

The invention is not limited to the above-described example, but includes various modification examples and equivalent configurations within the spirit of the appended claims. For example, the above-described example has been described in detail to describe the invention in an easy-to-understand manner, and the invention is not necessarily limited to having all of the configurations described. Furthermore, the elements described in parallel in this embodiment may be in a form in which at least one of the elements is connected to the other elements in series.

Furthermore, in the above-described embodiment, the processing may be described using a “system” or a “program” as the subject, but the system is a computer resource including a processor (for example, a central processing unit (CPU)), a storage resource (for example, a memory), and a communication interface device (for example, a network interface card (NIC)), and since the program is executed by the processor and performed by using the storage resource and/or the communication interface device as appropriate, the process may be a process performed by the processor or a computer including the processor as a subject.

The invention can be applied to operation management systems related to technology for executing processing for inputting and outputting data to and from a host.

What is claimed is:

1. An operation management system for a computer, the computer including a backup data store that stores backup data, and a restore computer resource that analyzes the backup data and restores the data, wherein
the operation management system,
when restoring the backup data to a logical volume in a virtual drive,
stores the restored backup data in an external volume of a high-speed virtual drive that is able to be accessed at higher speed than the virtual drive to control the restore computer resource so that the restored data is able to be accessed, and
migrates the restored data from the external volume of the high-speed virtual drive to the logical volume of the virtual drive while maintaining a state where the restored data in the external volume of the high-speed virtual drive is accessible.

2. The operation management system according to claim 1, wherein the restoration of the data by the restore computer resource and the configuration of the logical volume that stores the data are executed in parallel.

3. The operation management system according to claim 1, wherein input/output processing with respect to a host is restarted upon start of the migration.

4. The operation management system according to claim 1, wherein the operation management system selects the high-speed virtual drive that restores the data from among a plurality of virtual drives based on target restoration times, and performance and a usage fee of the virtual drives.

5. An operation management method for a computer, the computer including a backup data store that stores backup data, and a restore computer resource that analyzes the backup data and restores the data, wherein
the operation management method includes,
when an operation management system restores the backup data to a logical volume in a virtual drive,
an access control step of storing the restored backup data in an external volume of a high-speed virtual drive that is able to be accessed at higher speed than the virtual drive to control the restore computer resource so that the restored data is able to be accessed, and
a migration processing step of migrating the restored data from the external volume of the high-speed virtual drive to the logical volume of the virtual drive while maintaining a state where the restored data in the external volume of the high-speed virtual drive is accessible.
